(19) United States
(12) Patent Application Publication
(10) Pub. No.: US 2023/0099118 A1
(43) Pub. Date: Mar. 30, 2023

(54) SYSTEMS AND METHODS FOR ENHANCING THE EFFICIENCY OF SEPARATION PROCESSES

(71) Applicant: Khalifa University of Science and Technology, Abu Dhabi (AE)

(72) Inventor: Emad ALHSEINAT, Abu Dhabi (AE)

(21) Appl. No.: 17/798,455

(22) PCT Filed: Feb. 11, 2021
(86) PCT No.: PCT/IB2021/051143

§ 371 Date: Aug. 9, 2022

Related U.S. Application Data
(60) Provisional application No. 62/972,730, filed on Feb. 11, 2020.

(51) Int. Cl. C02F 1/48; B01D 1/00; B01D 5/00; B01D 61/14; B01D 61/16; B01D 61/18; C02F 1/44

(52) U.S. Cl. CPC C02F 1/487; B01D 1/0035; B01D 5/006; B01D 61/145; B01D 61/16; B01D 61/18; C02F 1/447; C02F 1/488; B01D 2311/04; B01D 2311/103; B01D 2311/2607; B01D 2311/2615; C02F 2201/009

(57) ABSTRACT

Embodiments of the present disclosure include systems and methods for enhancing the performance and efficiency of separation processes. The methods include flowing a fluid through a processing zone defined by an antiferromagnetic portion of a conduit and, as the fluid flows through the processing zone, exposing the fluid to a magnetic field produced by oscillating electromagnetic waves, wherein the direction of the magnetic field is generally counter to the direction in which the fluid is flowing. The systems include magnetic treatment units, separation systems, and the like.

### BACKGROUND OF THE INVENTION

It is generally accepted that a magnetic field can induce Lorentz force applied to moving charged particles, such as ions. In physics, the Lorentz force is the force on a point charge due to an electrical potential and magnetic field. It is given by the equation (1) below, in terms of the electric and magnetic fields:

F=q[E+(v×B)]

where F is the force in Newton; E is the electric field in volts per meter; B is the magnetic field in Tesla; and q is the electric charge of particle in coulombs; and v is the instantaneous velocity of particle in meters per second.

The magnetic field B will change the direction of electric charges motion according to their signs. This concept can be used to separate these ions from the fluid. See, for example, scheme 1 below:

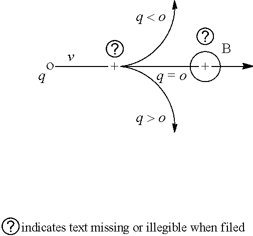

Scheme 1 shows the trajectory of a particle with charge q, under the influence of a magnetic field B directed perpendicularly out of the page, for different values of q.

There are only a few separation processes derived from the concept of equation (1) such as electrodialysis and capacitive deionization. In these two processes, deionization movement of ions takes place due to applied electrical potential, as there is no magnetic force and thus B equals zero. However, the electrodialysis process has a series of problems that contribute to the main problem of having high power consumption and correspondingly high operating costs. To overcome this problem in seawater desalination, the use of a magnetic field has been proposed instead of using an electric field which can solve the electro-neutrality of the cells of the edges. However, the potential drawbacks that need to be overcome are (a) the need for strong magnetic fields at the order of 5 Tesla, which may require the usage of superconductivity dipole; and (b) growth of the Donnan and Nernst potentials due to the increasing difference of concentration between the dilute channel and the concentrated channel. Although new, promising, materials which can achieve strong magnetic fields are being developed, the suggestion of using magnetic force instead of electrical potential is still far away from applicability. In order to create effective Lorentz forces capable of separating ions, a very high intensity magnetic field is required and obtaining such high intensity magnetic field is extremely difficult and expensive. However, low intensity magnetic field have yet to be explored and their effect on the solvent physicochemical properties, ion hydration, and thus ion-solvent interaction have yet to be exploited to enhance the performance of different separation processes.

### SUMMARY OF THE INVENTION

The present invention provides systems and methods for enhancing the performance and efficiency of separation processes.

In one aspect, the present invention provides a method of enhancing the efficiency of a separation process. The method comprises flowing a fluid through a processing zone defined by a nonmagnetic portion or an antiferromagnetic portion of a conduit and, as the fluid flows through the processing zone, exposing the fluid to a magnetic field produced by oscillating electromagnetic waves, wherein the direction of the magnetic field is generally counter to the direction in which the fluid is flowing.

In another aspect, the present invention provides a system for enhancing the efficiency of a separation process. The system comprises a conduit or a portion of a conduit comprising an antiferromagnetic material or a nonmagnetic material, wherein said conduit or conduit portion defines a processing zone; and an electromagnetic wave generator disposed proximal to the conduit and configured to produce oscillating electromagnetic waves to alter at least one property of the fluid, said property selected from a solvent property and a solute-solvent interaction, wherein a fluid flowing through the processing zone is exposed to a magnetic field produced by the oscillating electromagnetic waves and wherein a direction of the magnetic field is generally counter to the direction in which the fluid is flowing.

In a further aspect, the present invention provides a separation system. The separation system may include a separation unit; and a magnetic treatment unit in fluid communication with the separation unit, wherein the magnetic treatment unit comprises: a conduit or a portion of a conduit comprising an antiferromagnetic material or a nonmagnetic material, wherein said conduit or conduit portion defines a processing zone; and an electromagnetic wave generator disposed proximal to the conduit and configured to produce oscillating electromagnetic waves to alter at least one property of the fluid, said property selected from a solvent property i.e. surface tension, density and viscosity and a solute-solvent interaction i.e. hydration shell, effective ion size and mass transfer, wherein a fluid flowing through the processing zone is exposed to a magnetic field produced by the oscillating electromagnetic waves and wherein a direction of the magnetic field is generally counter to the direction in which the fluid is flowing.

The details of one or more examples are set forth in the description below. Other features, objects, and advantages will be apparent from the description and from the claims.

### BRIEF DESCRIPTION OF THE DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a schematic diagram of a membrane distillation process in accordance with one or more embodiments of the invention.

FIGS. 2A-2B are schematic diagrams of a magnetic treatment system in accordance with one or more embodiments of the invention.

FIG. 3 is a flowchart of a method of using a treatment system in accordance with one or more embodiments of the invention.

FIG. 4 is a graphical view showing the permeate flux before, during, and after magnetic treatment, in accordance with one or more embodiments of the invention.

FIG. 5 is a graphical view showing the temperature profiles of water feeds before, during, and after magnetic treatment, in accordance with one or more embodiments of the invention.

FIG. 6 is a graphical view showing the permeate flux over the course of 20 hours, in accordance with one or more embodiments of the invention.

FIG. 7 is a graphical view showing the permeate flux for artificial seawater before, during, and after magnetic treatment, in accordance with one or more embodiments of the invention.

FIG. 8 is a graphical view showing the temperature profiles of water feeds with different salinity levels, in accordance with one or more embodiments of the invention.

FIG. 9 is a graphical view showing the temperature profiles of water feeds for all trials, in accordance with one or more embodiments of the invention.

FIGS. 10A-10B are graphical views showing the removal efficiency through a Polyamide (PI) membrane for three levels of salinity with 30 ppm of phenol, where (a) is a bar plot examining the effect of magnetism and (b) is a scatter plot of removal efficiency against magnetic field exposure time (error bar represents ±5%), according to one or more embodiments of the invention.

FIG. 11 is a graphical view showing an improvement in activated carbon absorption capacity upon exposure of the feed solution to magnetic treatment, according to one or more embodiments of the invention.

### DETAILED DESCRIPTION

The present invention provides systems and methods that involve the magnetic treatment of fluids for enhancing the efficiency and performance of separation processes. More specifically, it has been discovered that magnetic treatment of fluids (e.g., magnetic fields applied to solvents) has an effect on solvent structure, solvent properties, and/or solvent-solute interactions and that this effect can be used to enhance the efficiency of various separation processes, including separation processes that rely on or are based on solvent properties. For example, electromagnetic waves may be used to alter the physicochemical properties of different solvents (e.g., water, amine solutions, and the like). The electromagnetic effects on the solvents may be utilized to enhance the efficiency of various separation processes (e.g., including without limitation adsorption processes, absorption processes, membrane processes like ultrafiltration processes, and the like). In addition, the mobility of ions and/or charged dissolved particles in a solvent is enhanced using the applied electromagnetic field and this may be used to improve ions and/or charged dissolved particles separations.

Some embodiments, for example, relate to electromagnetic treatment of a feed stream (e.g., a wastewater stream in wastewater treatment plants that use adsorption and/or ultrafiltration membrane processes). At least one advantage of the present invention is that electromagnetic wave sources may be installed over essentially any portion of a feed stream-line (pipe) before the fluid or feed enters a separation unit (e.g., such as adsorption and ultrafiltration membrane processes). The electromagnetic source may be installed over a non-magnetic portion of the feed stream-line (e.g., over austenitic stainless steels). The electromagnetic source may be installed over the non-magnetic portion of the feed stream-line without any direct contact with the treated feed stream. In this way, implementation of the systems and methods herein does not require any significant modification to the targeted separation process and therefore can be directly installed in existing running processes.

In embodiments, for example, magnetic treatment units are provided that comprise an antiferromagnetic conduit and an electromagnetic wave generator. The electromagnetic wave generator can be utilized to generate oscillating electromagnetic waves that produce a magnetic field in a direction that is generally counter or opposite to the direction in which a fluid is flowing. For example, a fluid can be exposed to the magnetic field as the fluid flows through the antiferromagnetic portion of the conduit. The fluid's exposure to the magnetic field can alter the structure of fluid molecules, increase the evaporation rate of the fluid, and enhance the mobility of dissolved ions. For example, in membrane distillation processes and other thermal water desalination processes, the magnetic treatment of saline water feeds can increase the production rate of desalinated water while also reducing the energy requirements of (or consumed by) the process. In another example, in adsorption processes the adsorption capacity and kinetic can be enhanced by the mentioned magnetic treatment of the feed stream. Another example, acid gases absorption by amine and physical solvent can be enhanced by the mentioned magnetic treatment of the feed stream.

As used herein, the term “fluid” generally refers to flowable particulate matter regardless of phase and/or constituent components. The term includes aqueous solutions comprising one or more salts in any ionic form. For example, the one or more salts can be present in solution as ionic compounds, free ions, hydrated ions, non-hydrated ions, combinations thereof, and the like. In some embodiments, the term refers to a saline water feed which is feed water comprising natural or artificial saltwater. Examples of saltwater include, without limitation, seawater, brine, reject streams from reverse osmosis operations, water produced from oil and gas wells, metallic pit water, industrial or residential wastewater, and the like. Examples of salts present in seawater include, without limitation, the following: sodium chloride, calcium chloride, calcium sulfate, magnesium chloride, magnesium sulfate, potassium chloride, potassium sulfate, and ionic forms thereof. These shall not be limiting, as seawater is known to comprise a multitude of salts and at least trace amounts of nearly every element in the periodic table.

The systems and methods disclosed herein are general and thus can be applied to a variety of different separation processes for the magnetic treatment of fluids. Examples of separation processes include, without limitation, sorption-based processes (e.g., sorption, adsorption, and/or absorption processes) membrane-based separation processes, non-membrane-based separation processes, evaporation-based separation processes, distillation-based separation processes, filtration-based separation processes, and the like. More specific examples of separation processes include, without limitation, membrane distillation system, vacuum membrane distillation system, direct contact membrane distillation system, air gap membrane distillation system, material gap membrane distillation system, osmotic membrane distillation system, multi-stage flash distillation system, multi-effect distillation system, mechanical vapor compression system, thermal vapor compression system, reverse osmosis, forward osmosis, nanofiltration, ultrafiltration, pervaporation, electrodialysis, and the like. Examples of non-membrane separation processes include, without limitation, distillation, adsorption, absorption, extraction, and the like. Further examples of separation processes include separation processes that rely on solvent properties.

Adsorption systems, absorption systems, ultrafiltration membrane systems, membrane distillation systems, and other thermal water desalination systems are a few examples of exemplary separation processes in accordance with one or more embodiments of the present invention. Membrane distillation systems and thermal water desalination systems can be used in a variety of applications including, for example and without limitation, water desalination (e.g., for producing desalinated water from saline water feeds), wastewater treatment, and in food industry. A typical membrane distillation system includes a membrane distillation unit having a feed side, a permeate side, and a microporous hydrophobic membrane, which separates the feed side from the permeate side. During operation, a hot feed stream passes through the feed side of the membrane distillation unit, while a cold feed stream passes through the permeate side of the membrane distillation unit. The temperature difference created between the feed and permeate sides induces a partial vapor pressure difference across the membrane that drives the separation process. Water passing through the feed side evaporates at the feed-membrane interface and permeates through the membrane's pores as water vapor. The water vapor then condenses on the permeate-membrane interface, producing fresh or desalinated water. Being hydrophobic, the membrane does not permit the liquid phase to wet or otherwise pass through the pores of the membrane to the permeate side of the membrane distillation unit.

In some embodiments, the magnetic treatment units disclosed herein are employed in membrane distillation systems. For example, the magnetic treatment units can be applied to saline water feeds to enhance the efficiency of the membrane distillation process and increase the production rate of desalinated water, while also reducing the energy requirements of—and thus the energy consumed by—membrane distillation systems. While not wishing to be bound to a theory, it is believed that the electromagnetic waves and, in particular, the oscillating electromagnetic waves produced by the oscillating magnetic field, can alter the saline water structure and enhance the evaporation rate of saline water which leads to increases in the freshwater production rate. For example, it is believed that the magnetic treatment of saline water feeds can weaken the solvation/hydration bonds between solvent and/or water molecules and salts. This weakening of the bonds can increase the evaporation rate and/or vapor pressure of the saline water feed in ways that can be exploited. For example, in membrane distillation processes, this increase in the vapor pressure leads to an increase in the permeate flux through the membrane (and thus an increase in the production rate of desalinated water), while lowering the energy consumed by the system. In some embodiments, the magnetic treatment of contaminated saline water can increase the removal efficiency of at least one contaminant. In some embodiments, for example, the entire membrane distillation system or at least a portion can be solar powered using solar water heaters, thermal solar collectors, solar photovoltaic systems, and the like.

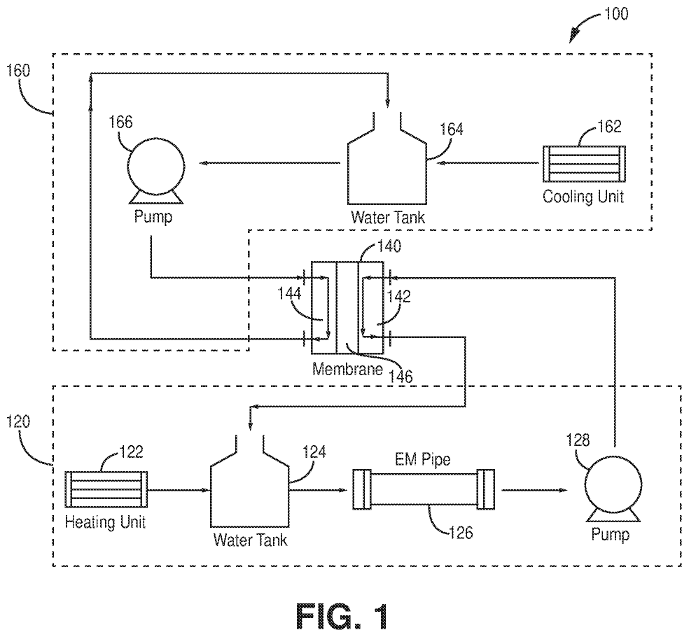

FIG. 1 is a schematic diagram of a membrane distillation system 100 for producing desalinated water from feed water comprising saltwater, in accordance with one or more embodiments of the present invention. As shown in FIG. 1, the membrane distillation system 100 comprises a feed subsystem 120, a membrane distillation unit 140, a permeate subsystem 160, and other auxiliary components including, for example and without limitation, conduits, pipes, diverters, pumps, control systems, sensors, valves, and the like. Although the system 100 is a membrane distillation system, any of the separation systems and processes of the present disclosure (e.g., adsorption systems and processes, absorption systems and processes, ultrafiltration membrane systems and processes, and the like) may be utilized herein without departing from the scope of the present invention.

The membrane distillation unit 140 comprises a feed side 142, a permeate side 144, and a microporous hydrophobic membrane 146 separating the feed side 142 from the permeate side 144. In the illustrated embodiment, the feed side 142 and permeate side 144 are arranged in co-current flow. In another embodiment, the feed side 142 and permeate side 144 are arranged in counter-current flow. In some embodiments, the hot magnetically treated saline water feed from the feed subsystem 120 flows through the feed side 142 of the membrane distillation unit 140, while a cold-water feed from the permeate subsystem 160 flows through the permeate side 144 of the membrane distillation unit 140. This temperature difference between the feed side 142 and permeate side 144 can induce a vapor pressure difference across the membrane that drives the separation process. For example, in some embodiments, water from the saline water feed evaporates at the feed-membrane interface on the feed side 142 and permeates across the microporous hydrophobic membrane 146 as water vapor. The water vapor on the permeate side 144 condenses, producing desalinated water.

Accordingly, the feed side 142 of the membrane distillation unit 140 is in fluid communication with the feed subsystem 120. The feed subsystem 120 comprises a heating unit 122, feed reservoir 124, magnetic treatment unit 126, and pump 128. The feed subsystem 120 is generally configured to convey a saline water feed from the feed reservoir 124 through the magnetic treatment unit 126 to the feed side 142 of the membrane distillation unit 140 and then back to the feed reservoir 124. For example, in some embodiments, the saline water feed is conveyed from the feed reservoir 124 to the magnetic treatment unit 126. The saline water feed exiting the magnetic treatment unit 126 is conveyed using pump 128 to the feed side 142 of the membrane distillation unit 140, where water vapor from the saline water feed permeates through the microporous hydrophobic membrane. From the membrane distillation unit 140, the saline water feed, now with an increased concentration of salt, is conveyed back to the feed reservoir 126 where said saline water feed can be held or stored for any duration. Additional saline water feed can be added to the system at any point. The saline water feed can be circulated through the feed subsystem 120 one or more times on a continuous or non-continuous basis.

In some embodiments, the heating unit 122 is provided upstream from the feed reservoir 124, downstream from the feed reservoir 124, coupled to the feed reservoir 124, or downstream from the magnetic treatment unit 126. For example, in the illustrated embodiment, the heating unit 122 is coupled to the feed reservoir 124 and configured to heat the saline water feed while it is being held in the feed reservoir 124. In this embodiment, the saline water feed can be conveyed from the feed side 142 of the membrane distillation unit 140 to the feed reservoir 124, where the feed water is stored and optionally heated by heating unit 122. In some embodiments, the heating unit 122 is provided downstream from the feed reservoir 124. In these embodiments, the saline water feed can be conveyed from the feed reservoir 124 to the heating unit 122 for optional heating and, from the heating unit 122, to the magnetic treatment unit 126. In some embodiments, the heating unit 122 is provided upstream from the feed reservoir 124. In these embodiments, the saline water feed can be conveyed from the feed side 142 of the membrane distillation unit 140 to the heating unit 122 for optional heating and, from the heating unit 122, to the feed reservoir 124. In some embodiments, the heating unit 122 is provided downstream from the magnetic treatment unit 126. In these embodiments, the saline water feed can be conveyed from the magnetic treatment unit 126 to the heating unit 122 for optionally heating and, from the heating unit 122, to the feed side 142 of the membrane distillation unit 140.

In some embodiments, the heating unit 122 is a solar water heater. For example, in some embodiments, the heating unit 122 is a solar thermal collector. In some embodiments, the saline water feed is heated using a solar thermal collector coupled to the feed reservoir 124 and then conveyed from the feed reservoir 124 to the magnetic treatment unit 126 at a temperature in the range of 40° C. to 65° C. Solar water heaters, such as solar thermal collectors, can be energy passive and thus do not require an external power supply in order to heat the saline water feed. Accordingly, at least one advantage of utilizing a solar thermal collector is to reduce the energy consumed by the membrane distillation system 100 which remains an ongoing challenge that limits the commercialization and widespread implementation of said systems. Other solar-powered heating units can be used herein. In other embodiments, conventional heating units can also be used. In some embodiment, solar devices can be used to power conventional heating units.

The optionally heated saline water feed can be directed to the magnetic treatment unit 126 shown in FIG. 1. As will be discussed in more detail below, the magnetic treatment unit 126 can comprise a conduit or a portion of a conduit comprising an antiferromagnetic material and an electromagnetic wave generator. The electromagnetic wave generator can be utilized to generate oscillating electromagnetic waves that produce a magnetic field in a direction that is generally counter or opposite to the direction in which the saline water feed would flow through the antiferromagnetic portion of the conduit. The antiferromagnetic portion of the conduit, regions in which the fluid would be or is exposed to the magnetic field, or both can define a processing zone. For example, in some embodiments, the optionally heated saline water feed is directed to the conduit and flows through the processing zone of the magnetic treatment unit 126. As the optionally heated saline water feed flows through the processing zone, the hot saline water feed is exposed to the magnetic field produced by the oscillating electromagnetic waves.

Once the saline water feed has been subjected to magnetic treatment using magnetic treatment unit 126 and heated to a temperature between about 45° C. to about 60° C. using the heating unit 122, the hot magnetically treated saline water feed can be directed to the membrane distillation unit 140.

The other side of the membrane distillation unit 140 is the permeate side 144. The permeate side 144 of the membrane distillation unit 140 is provided in fluid communication with the permeate subsystem 160. The permeate subsystem 160 comprises a cooling unit 162, permeate reservoir 164, and pump 166. The permeate subsystem 160 is generally configured to convey a cold-water feed from the permeate reservoir 164 to the permeate side 144 of the membrane distillation unit 140 and then back to the permeate reservoir 164. For example, in some embodiments, the cold-water feed is conveyed using pump 166 from the permeate reservoir 164 to the permeate side 144 of the membrane distillation unit 140. From the membrane distillation unit 140, the cold-water feed, now further including fresh water (condensed water vapor) from the membrane distillation unit, is conveyed back to the permeate reservoir 164 where said cold water feed can be held or stored for any duration. In some embodiments, fresh water is drawn from the permeate reservoir 164, among other places. The cold-water feed can be circulated through the permeate subsystem 160 one or more times on a continuous or non-continuous basis.

The cooling unit 162 is optional and can be provided upstream from the permeate reservoir 164, downstream from the permeate reservoir 164, or coupled to the permeate reservoir 164. For example, in the illustrated embodiment, the cooling unit 162 is coupled to the permeate reservoir 164 and configured to cool the feed water held in the permeate reservoir 164. In this embodiment, the feed water can be conveyed from the permeate side 144 of the membrane distillation unit 140 to the permeate reservoir 164, where the feed water is stored and optionally cooled via cooling unit 162. In some embodiments, the cooling unit 162 is provided downstream from the permeate reservoir 164. In these embodiments, the feed water can be conveyed from the permeate reservoir 164 to the cooling unit 162 for optional cooling and, from the cooling unit 162, to the permeate side 144 of the membrane distillation unit 140. In other embodiments, the cooling unit 162 is provided upstream from the permeate reservoir 164. In these embodiments, the feed water can be conveyed from the permeate side 144 of the membrane distillation unit 140 to the cooling unit 162 for optional cooling and, from the cooling unit 162, to the permeate reservoir 164.

In some embodiments, the present invention relates to direct contact membrane distillation systems in which magnetic treatment of saline water feeds increases the production rate of desalinated water. The magnetic treatment of saline water feeds can be performed using magnetic treatment units comprising an antiferromagnetic conduit and an electromagnetic wave generator. The electromagnetic wave generator is utilized to generate oscillating electromagnetic waves that produce a magnetic field in a direction that is counter or opposite to the direction in which the saline water feed is flowing. During operation of the membrane distillation system, the saline water feed flows through antiferromagnetic portion of the conduit where it is exposed to the magnetic field. This exposure can increase the vapor pressure and/or evaporation rate of the feed, leading to corresponding increases in the permeate flux through the membrane distillation unit and the production rate of desalinated water.

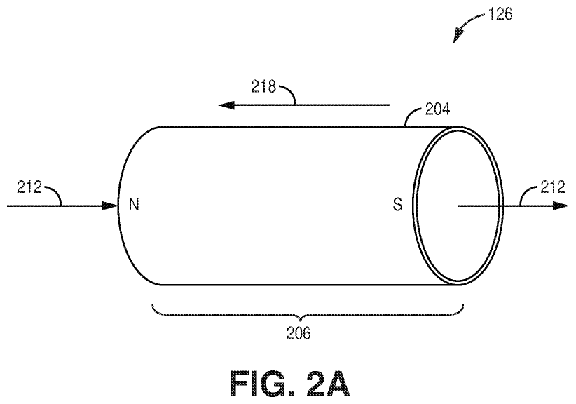

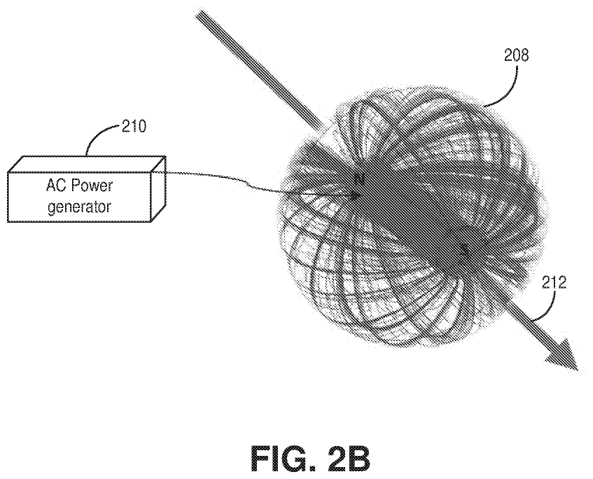

With continued reference to FIG. 1 and referring now also to FIGS. 2A-2B, the magnetic treatment unit 126 will be described further. In particular, schematic diagrams of the magnetic treatment unit 126 are presented in FIGS. 2A and 2B, in accordance with one or more embodiments of the invention.

As shown in FIGS. 2A-2B, the magnetic treatment unit 126 generally includes a conduit or a portion of a conduit 204 and an electromagnetic wave generator 210. The electromagnetic wave generator 210 can be configured to generate oscillating electromagnetic waves that produce a magnetic field 208 in a direction that is generally counter or opposite to the direction in which the fluid flows or would flow through the conduit or conduit portion 204. For example, directional component 212 can indicate the general direction in which fluids flow through the conduit or conduit portion 204, whereas directional component 214 can indicate the general direction of the magnetic field 208. The magnetic treatment system 126 can further include a processing zone 206. The processing zone 206 can be defined by the antiferromagnetic portion of the conduit, a non-magnetic portion of the conduit, the region in which the fluid is or would be exposed to the magnetic field, or any combination thereof. In certain embodiments, the processing zone 206 is defined by the antiferromagnetic portion of the conduit 204, provided that a fluid flowing through said portion of the conduit 204 is or would be at least partially exposed to the magnetic field 208.

The conduit or conduit portion 204 can include any antiferromagnetic material and/or nonmagnetic material. For example, in some embodiments, the conduit or conduit portion 204 may comprise, consist essentially of, or consist of a material selected from the group consisting of an antiferromagnetic material, a nonmagnetic material, and a combination thereof. As used herein, the term “antiferromagnetic material” generally refers to materials that exhibit antiferromagnetism. For example, the term includes substances in which the direction of electron spins is antiparallel such that the magnetization of the substance as a whole is zero. In some embodiments, the conduit or conduit portion 204 includes austenitic stainless steel.

In some embodiments, the antiferromagnetic material is selected from metal alloys, metal oxides, ionic solids, mixtures thereof, and the like. In some embodiments, the antiferromagnetic material comprises a metal selected from transition metals. In some embodiments, the antiferromagnetic material comprises one or more of the following elements: Mn, Cr, Ir, Fe, Rh, Pt, Pd, Ni, Os, Tc, Ru, Re, Ag, Au, and Al. In some embodiments, the antiferromagnetic material comprises Mn and at least one of the following elements: Cr, Ir, Fe, Rh, Pt, Pd, Ni, and Os. In some embodiments, the antiferromagnetic material comprises Cr and at least one of the following elemements: Mn, Tc, Ru, Rh, Re, Os, Ir, Pd, Pt, Ag, Au, and Al. In some embodiments, the antiferromagnetic material is a metal alloy of Ir and Mn. In some embodiments, the antiferromagnetic material is a metal alloy of Rh and Mn. In some embodiments, the antiferromagnetic material is a metal alloy of Fe and Mn. In some embodiments, the antiferromagnetic material is selected from PtMn, NiMn, IrMn, OsMn, PdPtMn, CrPtMn, NiO, CoO, CoNiO, and PtCr.

In some embodiments, the conduit or conduit portion 204 is made or composed of the antiferromagnetic material and thus the antiferromagnetic portion of the conduit 204 is in direct contact with the saline water feed flowing through the magnetic treatment unit 126. In some embodiments, the antiferromagnetic material is disposed as a layer or coating on an inner surface of the conduit or conduit portion 204 and thus is similarly in direct contact with the saline water feed flowing through the magnetic treatment unit 126. In some embodiments, the antiferromagnetic material is disposed as a layer or coating on an outer surface of the conduit or conduit portion 204 and thus is not in direct contact with the saline water feed flowing through the magnetic treatment unit 126.

Other than including the antiferromagnetic material, the conduit or conduit portion 204 is not particularly limited. For example, the conduit or conduit portion 204 can have a circular cross-section, elliptical cross-section, oblong cross-section, square cross-section, rectangular cross-section, polygonal cross-section, or triangular cross-section. The diameter of the conduit or conduit portion 204 can vary along the length of the conduit or it can be constant or uniform. The diameter, conduit length, thickness, and other dimensions can each be independently selected based on process variables and other parameters (e.g., flow rate, fluid volume, etc.) of the membrane distillation system and/or thermal water desalination system.

The electromagnetic wave generator 210 can be mounted or installed on or near (e.g., proximal to) the conduit or conduit portion 204 to permit integration with the infrastructure of existing separation processes. At least one advantage of the present invention is that the magnetic treatment unit 126 can be easily and readily installed on or integrated with the infrastructure of existing separation processes and other related operating plants. For example, in some embodiments, existing separation operations can be equipped with the magnetic treatment unit 126 simply through the installation of an electromagnetic wave generator 220 on or near a conduit provided upstream of a membrane distillation unit. Accordingly, major modification of existing infrastructure, while permitted, is not required for implementation of the present invention. In some embodiments, integration of the magnetic treatment unit 126 includes installing an antiferromagnetic conduit in the feedline of a new or existing separation process, as well as an electromagnetic wave generator 210. In some embodiments, the electromagnetic wave generator 210 is installed over a nonmagnetic portion of the conduit or conduit portion and/or without any direct contact with the treated feed stream.

The electromagnetic wave generator can be configured to generate the oscillating electromagnetic waves that produce the magnetic field. Alternating current (AC) power generators and other similar devices can be utilized herein as the electromagnetic wave generator, which is not particularly limited. In some embodiments, the electromagnetic wave generator is solar-powered. For example, in some embodiments, the electromagnetic wave generator is powered by solar photovoltaic systems.

In some embodiments, the electromagnetic wave generator is configured to sweep frequencies in the radio frequency band at a predetermined rate. For example, in some embodiments, the electromagnetic wave generator is configured to sweep frequency responses between 200 Hz to 20,000 Hz at a rate of 10 to 20 times per second. In some embodiments, this means that the frequency changes from 200 Hz to 20,000 Hz and back to 200 Hz at a rate of 10 to 20 times per second. In other embodiments, this means that the frequency changes from 200 Hz to 20,000 Hz at a rate of 10 to 20 times per second. Other frequency ranges and rates can be utilized herein without departing from the scope of the present invention. For example, in general, the electromagnetic wave generator can be configured to sweep frequency responses anywhere between 30 Hz and 300 GHz, or any incremental value or subrange between that range, at a rate between 1 to 100 times per second, or any incremental value or subrange between that range.

In some embodiments, the strength of the magnetic field produced by the oscillating electromagnetic waves can generally range from about 5 mT to about 5 T, or any incremental value or subrange between that range. For example, in some embodiments, the strength of the magnetic field ranges from about 25 mT to about 50 mT. In some embodiments, the strength of the magnetic field is at least about 25 mT. In some embodiments, the strength of the magnetic field is at least about 20 mT. In some embodiments, the strength of the magnetic field is at least about 15 mT.

In some embodiments, the fluids include one or more of water, one or more solvents, one or more salts, and one or more solvents. The fluids that can be used with the magnetic treatment unit 126 include optionally heated saline water feeds, or water feeds comprising seawater as described above. In some embodiments, the seawater comprises one or more salts, where the salts are selected from the group consisting of: sodium chloride, calcium chloride, calcium sulfate, magnesium chloride, magnesium sulfate, potassium chloride, potassium sulfate, and ionic forms thereof. Examples of contaminants include one or more of phenols, heavy metals, dissolved particles, pharmaceuticals, and pesticides. Examples of solvents include one or more of water, amine solutions, and physical solvent types for gas processing, such as for example one or more of dimethylether, polyethylene glycol, propylene carbonate, ionic liquids, deep eutectic solvents, and the like. In some embodiments, for example, the solvents include a blend of water and amine solutions.

The salt concentration of the saline water feed is not particularly limited. In some embodiments, the salt concentration of the saline water feed is about 500 ppm or greater, or any incremental value or subrange between that range. In some embodiments, the salt concentration of the saline feed water is about 500 ppm or less, or any incremental value or subrange between that range. In some embodiments, the salt concentration of the saline water feed is about 100 ppm or less. In some embodiments, the salt concentration of the saline water feed is about 50 ppm or less. For example, in one embodiment, the salt concentration of the saline water feed is about 35 ppm. In another embodiment, the salt concentration of the saline water feed is about 10 ppm.

In some embodiments, the saline water feed is optionally heated prior to flowing through the magnetic treatment unit 126. In some embodiments, the saline water feed is heated to a temperature in the range of about 45° C. to about 60° C. prior to flowing through the magnetic treatment unit 126. In some embodiments, the saline water feed is heated to a temperature in the range of 45° C. to about 60° C. after the saline water feed has passed through the magnetic treatment unit 126. In some embodiments, the saline water feed is heated to a temperature in the range of about 40° C. to about 65° C. prior to flowing through the magnetic treatment unit 126. In some embodiments, the saline water feed is heated to a temperature in the range of 40° C. to about 65° C. after the saline water feed has passed through the magnetic treatment unit 126.

In some embodiments, the magnetic treatment has no effect on fluid temperature. For example, in some embodiments, the temperature of the saline water feed at the inlet of the magnetic treatment unit 126 and temperature of the same feed at the outlet of the magnetic treatment unit 126 is the same (e.g., substantially the same). In some embodiments, the temperature change of the saline water feed at the inlet and outlet of the magnetic treatment unit 126 is less than about 20%, less than about 15%, less than about 10%, less than about 5%, less than about 1%, or less than about 0.5%. For example, in one embodiment, the change in temperature of the saline water feed at the inlet and outlet of the magnetic treatment unit 126 is about 1° C. or less. In another embodiments, the change in temperature of the saline water feed at the inlet and outlet of the magnetic treatment unit 126 is no more than 5° C.

In some embodiments, the magnetic treatment of the fluid weakens the solvation and/or hydration bonds between solvent and/or water molecules and salts. In some embodiments, the magnetic treatment of the fluid increases the vapor pressure or partial vapor pressure of said fluid. For example, in some embodiments, the magnetic treatment of the saline water feed increases the vapor pressure or partial vapor pressure of the saline water feed on or in the feed side of the membrane distillation unit. For example, in some embodiments, the vapor pressure and/or partial vapor pressure of the saline water feed at the processing zone/conduit outlet is greater than the (partial) vapor pressure of the saline water feed at the processing zone/conduit inlet of the magnetic treatment unit. In some embodiments, the magnetic treatment of the saline water feed increases the evaporation rate of the saline water feed on the feed side of the membrane distillation unit. In some embodiments, the magnetic treatment of the saline water feed increases the permeate flux of water vapor through the microporous hydrophobic membrane relative to saline water feeds not subjected to magnetic treatment. In some embodiments, the magnetic treatment of the saline water feed increases the production rate of the desalinated water from the saline water feed relative to saline water feeds not subjected to magnetic treatment.

In some embodiments, the magnetic treatment of the fluid can increase the permeate flux through the membrane and/or the fluid production rate. For example, in some embodiments, the magnetic treatment of the saline water feed can increase the permeate flux through the membrane and/or the production of desalinated water by about 5% to about 10%. In some embodiments, the magnetic treatment of the saline water feed can increase the permeate flux through the membrane and/or the production of desalinated water by about 0.1% to about 20%, or any incremental value or subrange between that range.

In some embodiments, the magnetic treatment of the fluid can increase or enhance the efficiency of a separation process. In some embodiments, the magnetic treatment increases the flux of a fluid through a separation membrane. In some embodiments, the magnetic treatment alters a physicochemical property of a solvent (e.g., water, amine solutions, etc.). In some embodiments, the magnetic treatment increases the mobility of ions and/or charged dissolved particles in the solvent to improve separations involving ions and/or charged dissolved particles. In some embodiments, the magnetic treatment alters at least one property of a fluid, said property being selected from a solvent property, a solute-solvent interaction, and a combination thereof. For example, exposing saline water to magnetic treatment can enhance the ion diffusion coefficient. Also, exposing amine solutions such as Diethanolamine to magnetic treatment can alter physicochemical properties, such as for example one or more of surface tension and its cyclohexane extraction power.

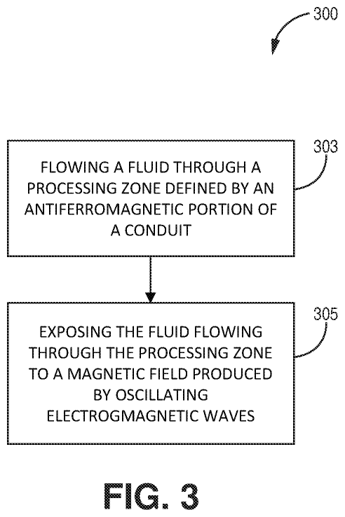

FIG. 3 is a flowchart of a thermal desalination process, in accordance with one or more embodiments of the invention. As shown in FIG. 3, the method 300 includes one or more of the following steps: heating 301 a fluid to a predetermined temperature (not shown); flowing 303 a fluid through a conduit comprising an antiferromagnetic material; exposing 305 the fluid to a magnetic field produced by oscillating electromagnetic waves; and directing 307 the fluid to a membrane distillation unit (not shown). The method 300 can be implemented with the membrane distillation systems and thermal water desalination systems of the present disclosure, such as those described in FIGS. 1 and 2A-2B, or the method 300 can be implemented with the other separation processes described herein.

In some embodiments, the method 300 includes optionally heating 301 a saline water feed to a temperature in the range of about 0° C. to about 200° C., preferably about 5° C. to about 45° C., more preferably about 15° C. to about 55° C., most preferably about 45° C. to about 60° C. In some embodiments, this step is performed using the heating unit 122. For example, in one embodiment, a solar water heater is used. In another embodiment, a solar thermal collector is used. The saline water feed can include any of the salts and/or other components disclosed herein. In some embodiments, the saline water feed includes feed water comprising seawater. In some embodiments, the seawater comprises one or more salts selected from the group consisting of sodium chloride, calcium chloride, calcium sulfate, magnesium chloride, magnesium sulfate, potassium chloride, potassium sulfate, and ionic forms thereof.

In some embodiments, the optionally heated saline water feed flows 303 through the conduit or a portion of the conduit comprising the antiferromagnetic material which are described above in more detail and elsewhere herein.

In some embodiments, as the optionally heated saline water feed flows 305 through the antiferromagnetic portion of the conduit and/or processing zone, the optionally heated saline water feed is exposed, either intermittently or continuously, to oscillating electromagnetic waves that produce the magnetic field in a direction that is generally counter or opposite to the direction in which the saline water feed flows through the conduit or conduit portion. The details of the oscillating electromagnetic waves and magnetic fields are described above. For example, in some embodiments, the oscillating electromagnetic waves sweep frequency responses between 200 Hz to 20,000 Hz at a rate of 10 to 20 times per second. In some embodiments, the strength of the magnetic field is between about 25 mT to about 50 mT.

In some embodiments, the magnetically treated saline water feed is directed 307 to the feed side of the membrane distillation unit. The evaporation rate and/or (partial) vapor pressure of magnetically treated saline water feed can be greater than the evaporation rate and/or (partial) vapor pressure of saline water feed not subjected to any magnetic treatment. The permeate flux of water vapor through the membrane can be greater in processes utilizing magnetically treated saline water feed than processes utilizing saline water feeds not subjected to magnetic treatment.

In one embodiment, the method 300 of enhancing the efficiency of a separation process comprises the steps of flowing 303 a fluid through a processing zone defined by an antiferromagnetic portion of a conduit and exposing 305 the fluid flowing through the processing zone to a magnetic field produced by oscillating electromagnetic waves.

In another embodiment, the method 300 of enhancing the efficiency of a separation process comprises the steps of heating 301 a fluid to a predetermined temperature; flowing 303 a fluid through a processing zone defined by an antiferromagnetic portion of a conduit; and exposing 305 the fluid flowing through the processing zone to a magnetic field produced by oscillating electromagnetic waves.

In a further embodiment, the method 300 of enhancing the efficiency of a separation process comprises the steps of flowing 303 a fluid through a processing zone defined by an antiferromagnetic portion of a conduit; exposing 305 the fluid flowing through the processing zone to a magnetic field produced by oscillating electromagnetic waves; and directing 307 the fluid from the processing zone to a feed side of a membrane distillation unit.

In yet another embodiment, the method 300 of enhancing the efficiency of a separation process comprises the steps of heating 301 a fluid to a predetermined temperature; flowing 303 a fluid through a processing zone defined by an antiferromagnetic portion of a conduit; exposing 305 the fluid flowing through the processing zone to a magnetic field produced by oscillating electromagnetic waves; and directing 307 the fluid from the processing zone to a feed side of a membrane distillation unit.

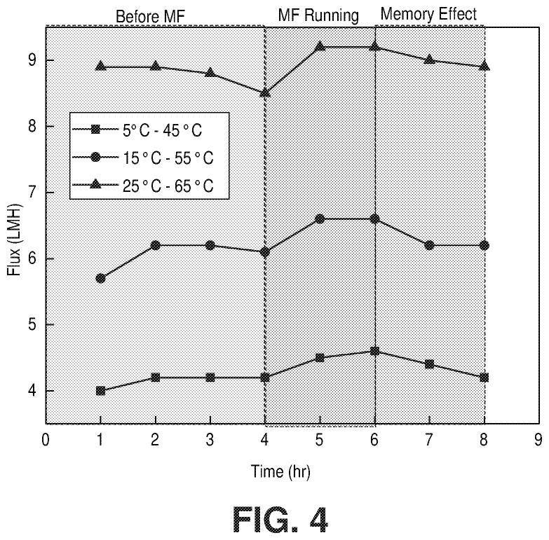

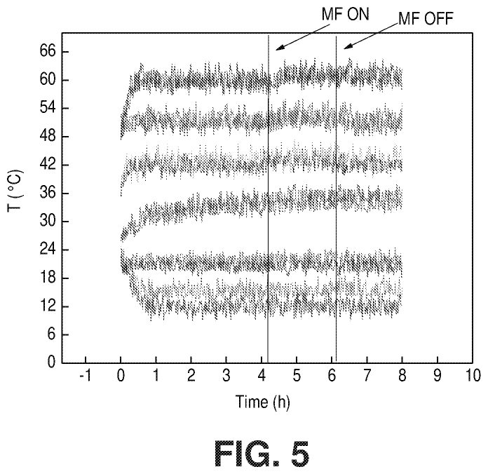

FIGS. 4, 6, 7, and 8 show that applying the electromagnetic field on the feed water of a membrane distillation process can enhance the permeation rate through the membrane. During periods in which the electromagnetic field is not being applied, the permeate flux was observed to decline back to the same flux that was observed before application of the magnetic field. This effect was confirmed for various feed waters with differing salinity and composition. While not wishing to be bound to a theory, it is believed that this effect is the result of the magnetic field on the hydration bond of water molecules. In particular, the magnetic field can weaken the hydration bonds between water molecules and other chemical species, such as salts, which leads to an increase in the evaporation rate of the feed water. Given that the main driving force of permeation in membrane distillation processes is the difference in vaper pressure between the feed and permeate sides of the membrane distillation unit, the magnetic field thus increases the vapor pressure in the feed side of the membrane distillation unit, which results in a corresponding increase in the permeate flux. It was confirmed that the enhancement or increase in permeate flux through the membrane was not the result of increases in the temperature of feed water upon being exposed to the magnetic. In particular, the temperature of the feed side was monitored along all experiments. As can be seen in FIGS. 5, 8, and 9, the change in temperature of the feed water was only 1° C. after applying the MF for a duration of four hours. The results thus show that temperature change is minimal.

FIG. 4 shows that the membrane distillation permeate flux (product flux) increased after exposing the feed water to the magnetic field. The results were consistent across all three experiments. Demonstrating that the magnetic field had an effect on the performance of the membrane distillation process. Moreover, after switching off the magnetic field, the permeate flux gradually decreased back to the initial flux observed in the absence of the magnetic field.

FIG. 5 shows that no significant change in feed water temperature was observed after exposing the feed water to the electromagnetic field for a duration of two hours, which confirmed that the increase in permeate flux was a result of the effect of magnetic field.

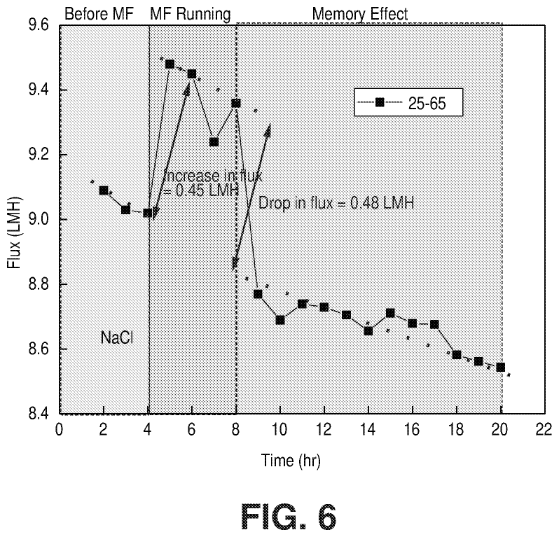

FIG. 6 shows the stability of the results over extended durations. The results further show that the effect of the magnetic field can be observed almost instantly, for example, within the first hour of product collection, which is indicative of the highly efficient magnetic mechanism acting on the solvation bonds of the NaCl—H₂O. The gradual decrease in permeate flux over time was attributed to the increase in salinity of the hot feed water, which was due to the mass transport of water from the salty side to the fresh water or permeate side.

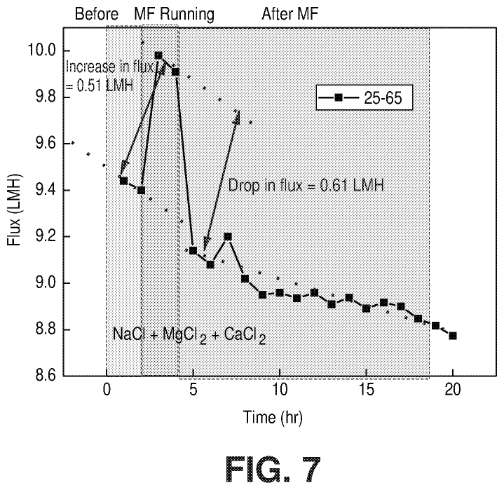

Artificial seawater was prepared following the composition of seawater by adding MgCl₂ and CaCl₂ to a NaCl solution. Sulfate and carbonate ions were excluded to avoid scaling. FIG. 5 shows the permeate flux of the artificial seawater MD experiments for 20 hr. FIG. 7 presents a comparison between the experiments with NaCl only and with the artificial seawater. The presence of MgCl₂ and CaCl₂ can result in a higher increase in permeate flux, which was equal to 0.51 LMH (as compared to 0.45 LMH when only NaCl is present). This results can be attributed to the higher magnetic field effect on the Mg²⁺ and Ca²⁺ divalent ions as compared to Na ions.

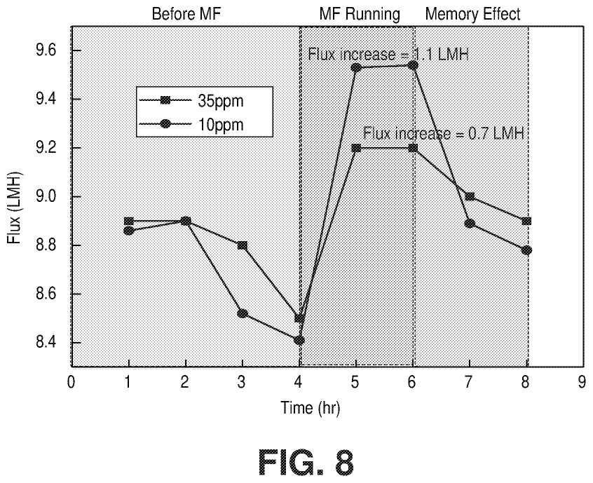

The effect of feed salinity on permeate flux is shown in the FIG. 8. The magnetic field was more effective at lower concentrations as compared to higher concentrations. An increase of 1.1 LMH was recorded for the 10 ppm solution which showed a significant improvement in the effect of magnetic field on the solvation of NaCl.

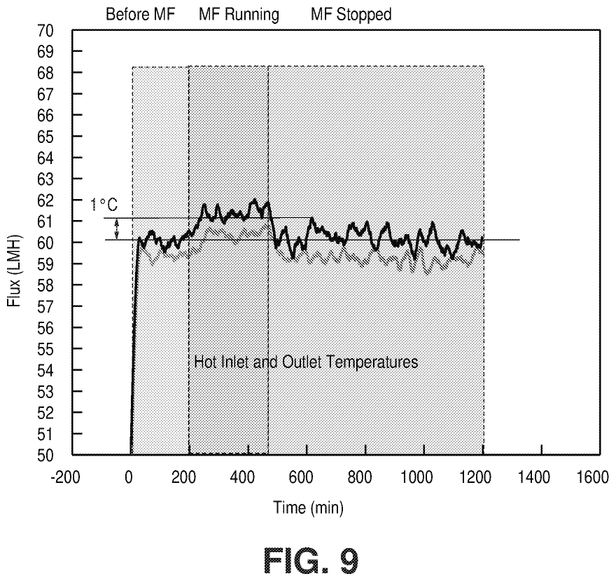

FIG. 9 shows the flux vs. temperature graph which is typical for all experiments show that the change in temperature was only 1° C. The results indicate that temperature change was minimal. The rejection was >99% for all experiments.

### Example 1

### Enhancing Efficiency of Ultrafiltration Membrane Process

This example involves the use of phenol solutions to represent wastewater, with phenol being the contaminant Phenol solutions with different ranges of salinities (e.g., 0 ppm NaCl, 5000 ppm NaCl, and 10000 ppm NaCl) and phenol concentrations were exposed to an electromagnetic field (EMF) prior to filtration through an ultrafiltration membrane, with some of the phenol solutions not being subjected to EMF exposure. Experiments were conducted to correlate removal efficiency with salinity and phenol concentration. The flux and removal efficiency was measured periodically over the course of a total magnetic treatment exposure time of about 2 hours. Measurements were also taken against magnetic treatment exposure time to identify the minimum required exposure time and performance stability.

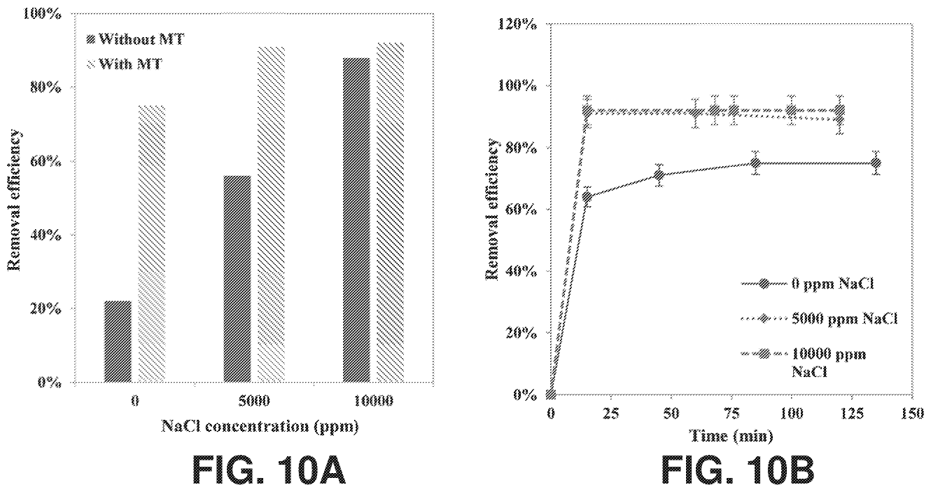

The results demonstrated enhanced removal efficiency at high salinities and impedance with increasing concentration. The greatest removal efficiency was achieved for a solution including about 50 ppm phenol and about 10000 ppm NaCl, at 1.3 h of magnetic exposure. FIGS. 10A-10B are graphical views showing the removal efficiency through the PI membrane for three levels of salinity—0 ppm NaCl, 5000 ppm NaCl, and 10000 ppm NaCl—and 30 ppm of phenol. FIG. 10A is a bar plot showing the effect of magnetism on the removal efficiency for various NaCl concentrations. In FIG. 10A, the sole impact of magnetic treatment at different salinity levels on phenol removal is evidence, where the increase from dilute to the highest concentration contributed to a 66% increase in removal efficiency. FIG. 10B is a scatter plot showing the removal efficiency against magnetic field exposure time. In FIG. 10B, the enhancement in removal efficiency upon magnetic treatment is shown, where it can be seen that the exposure time made a significant difference for the dilute solution as it increased from 64% at 15 minutes to 75% at 85 minutes.

The effect of the magnetic field (MF) was achieved instantly after exposing the saline water to the magnetic field. The Lorentz forces resulting from the applied magnetic field affected the ion clusters causing an increase in mobility and a weakening of the solute/solvent interactions, and also increased cation diffusion coefficients as can be seen in table 1.

TABLE 1
Analysis of Electrochemical impedance spectroscopy
results showing the increase in diffusion coefficients
(D) of NaCl and CaCl2 after the MF was applied.

| | | | D Without MF | D With MF | Increase |
|---|---|---|---|---|---|
| | Applied E (V) | | (cm² s⁻¹) | (cm² s⁻¹) | (%) |
| NaCl | 0.5 | (V) | 6.97 × 10⁻⁶ | 1.15 × 10⁻⁵ | 39.2 |
| | 1 | (V) | 5.26 × 10⁻⁶ | 1.07 × 10⁻⁵ | 51.1 |
| CaCl₂ | 0.5 | (V) | 1.77 × 10⁻⁷ | 2.68 × 10⁻⁷ | 34.2 |
| | 1 | (V) | 2.05 × 10⁻⁷ | 7.25 × 10⁻⁷ | 71.7 |

Table 2 shows the values of surface tension measured at room temperature for both a magnetized and fresh sample of a 25 wt % DEA solution. It can be seen that, exposing the amine solution reduced its surface tension by more than 20% of its initial value of 63.68 mN/m.

TABLE 2
Surface tension measurements for both
Magnetized and Fresh 25 wt % DEA solution
measured at ambient temperature and pressure.
Υ (mN/m)

| Fresh 25 wt % DEA Soln | Magnetized 25 wt % DEA Soln |
|---|---|
| 63.6785 ± 0.0145 mN/m | 50.602 ± 0.0295 mN/m |

### Example 2

### Enhancing the Efficiency of Adsorption Process

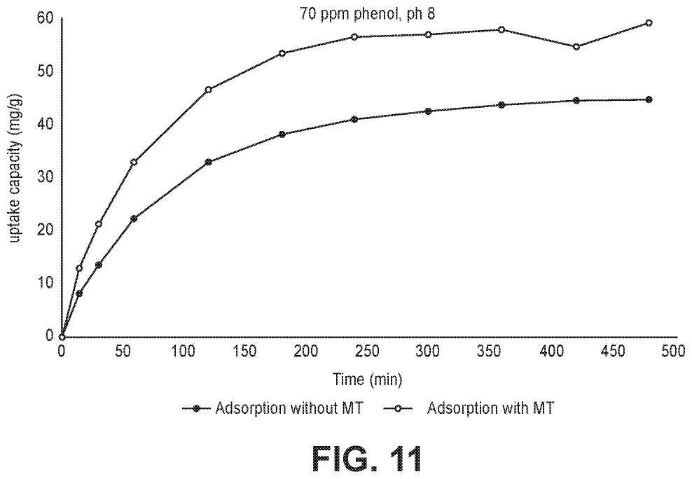

This example evaluates the effect of magnetic treatment on the activated carbon adsorption capacity of phenol solution. FIG. 11 shows an improvement in activated carbon absorption capacity upon exposure of the feed solution to magnetic treatment. As can be seen from FIG. 11, adsorption kinetics were enhanced by magnetic treatment as contaminant removal rate increased (e.g., became faster). Activated carbon is an example of an adsorbent used to remove phenol as a contaminant from water at pH 8. Initially, the water with 70 ppm phenol was passed through the activated carbon. The change in phenol was recorded with time until no further change was obtained. Then the same experiment with same conditions was repeated, except that the water with the 70 ppm phenol was exposed to the magnetic treatment immediately before it entered to the activated carbon. Significant enhancement in the removal capacity and speed or rate were observed as can be seen in FIG. 11.

1. A method of increasing the efficiency of a separation process, the method comprising:
flowing a fluid through a processing zone defined by a nonmagnetic portion or an antiferromagnetic portion of a conduit and, as the fluid flows through the processing zone, exposing the fluid to a magnetic field produced by oscillating electromagnetic waves, wherein the direction of the magnetic field is generally counter to the direction in which the fluid is flowing.

2. The method according to claim 1, wherein the fluid includes at least one of water, one or more solvents, one or more salts, and one or more contaminants.

3. The method of claim 1, wherein the fluid comprises at least one of sodium chloride, calcium chloride, calcium sulfate, magnesium chloride, magnesium sulfate, potassium chloride, potassium sulfate, and ionic forms thereof.

4. The method of claim 1, wherein the antiferromagnetic portion of the conduit comprises one or more of Mn, Cr, Ir, Fe, Rh, Pt, Pd, Ni, Os, Tc, Ru, Re, Ag, Au, and Al.

5. The method of claim 1, wherein the antiferromagnetic portion of the conduit comprises an antiferromagnetic material selected from the group consisting of PtMn, NiMn, IrMn, OsMn, PdPtMn, CrPtMn, NiO, CoO, CoNiO, and PtCr.

6. The method of claim 1, wherein the oscillating electromagnetic waves sweep frequency responses between 200 to 20,000 Hz at a rate of 10 to 20 times per second.

7. The method of claim 1, wherein the strength of the magnetic field is in the range of about 25 mT to about 50 mT.

8. The method of claim 1, wherein exposing the fluid to electromagnetic waves increases the temperature by no more than 5° C.

9. The method of claim 1, wherein exposure of the fluid to the magnetic field alters at least one property of the fluid, wherein the property is selected from a solvent property, a solvent-solute interaction, and a combination thereof.

10. The method of claim 1, wherein the vapor pressure of the fluid at the processing zone outlet is greater than the vapor pressure of the fluid at processing zone inlet.

11. The method of claim 1, wherein, prior to flowing through the processing zone, the fluid is heated to a temperature in the range of 45° C. to 60° C.

12. The method of claim 1, wherein the separation process is an adsorption process or an ultrafiltration membrane process, and wherein the processing zone is upstream from the separation process.

13. A system for enhancing the efficiency of a separation process, the system comprising:
a conduit or a portion of a conduit comprising an antiferromagnetic material or a non-magnetic material, wherein said conduit or conduit portion defines a processing zone; and
an electromagnetic wave generator disposed proximal to the conduit and configured to produce oscillating electromagnetic waves, wherein a fluid flowing through the processing zone is exposed to a magnetic field produced by the oscillating electromagnetic waves to alter at least one property of the fluid, said property selected from a solvent property and a solute-solvent interaction, and wherein a direction of the magnetic field is generally counter to the direction in which the fluid is flowing.

14. The system according to claim 13, wherein the antiferromagnetic material is selected from the group consisting of PtMn, NiMn, IrMn, OsMn, PdPtMn, CrPtMn, NiO, CoO, CoNiO, and PtCr.

15. The system of claim 13, wherein the electromagnetic wave generator is configured to sweep frequency responses between 200 to 20,000 Hz at a rate of 10 to 20 times per second.

16. The system of claim 13, wherein the strength of the magnetic field is in the range of about 25 mT to about 50 mT.

17. A separation system, comprising:
a separation unit; and
a magnetic treatment unit for enhancing the efficiency of a separation process, the magnetic treatment unit in fluid communication with the separation unit, wherein the magnetic treatment unit comprises:
a conduit or a portion of a conduit comprising an antiferromagnetic material or a non-magnetic material, wherein said conduit or conduit portion defines a processing zone; and
an electromagnetic wave generator disposed proximal to the conduit and configured to produce oscillating electromagnetic waves, wherein a fluid flowing through the processing zone is exposed to a magnetic field produced by the oscillating electromagnetic waves to alter at least one property of the fluid, said property selected from a solvent property and a solute-solvent interaction, and wherein a direction of the magnetic field is generally counter to the direction in which the fluid is flowing.

18. The system according to claim 17, wherein the separation unit is an adsorption unit, an absorption unit, or an ultrafiltration membrane.

19. The system of claim 17, further comprising a solar water heater upstream from the magnetic treatment unit, wherein the solar water heater is configured to heat a feed water to a temperature between about 40° C. and about 65° C.

20. The system of claim 17, wherein the electromagnetic wave generator is configured to sweep frequency responses between 200 to 20,000 Hz at a rate of 10 to 20 times per second.
